(19) United States
(12) Patent Application Publication
(10) Pub. No.: US 2012/0155606 A1
(43) Pub. Date: Jun. 21, 2012

(54) COMPUTER TOMOGRAPHIC WORKPIECE MEASURING DEVICE

(75) Inventors: Martin Simon, Uhldingen-Muhlhofen (DE); Siegfried Heeg, Heinrichthal (DE); Ralf Hock, Waldaschaff (DE); Manfred Etzel, Wiesthal (DE); Uwe Hilpert, Singen (DE); Severin Ebner, Bermatingen (DE)

(73) Assignee: WENZEL VOLUMETRIK GMBH, Singen (DE)

(21) Appl. No.: 13/266,881

(22) PCT Filed: Apr. 30, 2010
(86) PCT No.: PCT/EP2010/002650

§ 371 Date: Mar. 13, 2012

(30) Foreign Application Priority Data
Apr. 30, 2009 (DE) 10 2009 019 215.8

(51) Int. Cl. H05G 1/02; H05G 1/60

(52) U.S. Cl. 378/19; 378/20

(57) ABSTRACT

A marine device has a floating buoy containing electronics, a submerged payload containing electrical devices and electronics, a power source and a mooring line. At least a part of the power source is submerged and electrically connected to at least one of the submerged payload and the floating buoy, and the mooring line extends between the buoy and at least one of the power source submerged part, the submerged payload and a submerged anchor having a mass allowing it to stay under the water surface.

### BACKGROUND

The present invention relates to a computer-tomographic workpiece measuring device in accordance with the preamble of the main claim.

Devices of this type for non-medical computer tomography are generally known from the prior art and are based on the measuring principle, analogous to human medical or veterinary computer tomography, of subjecting workpieces to a high-power x-ray beam as invasive radiation and radiographing the same, the workpiece typically being located as a measurement object on a rotary table as workpiece support between a (high-power) x-ray source and an electronic x-ray detector. The detector absorbs the x-ray beams penetrating the object pixel by pixel by means of suitable detector pixels. By rotating the workpiece to be measured or tested using the rotary table, a plurality of x-ray images from different directions (perspectives) can be created, which are then combined as volume data in a downstream analysis unit to form a three-dimensional model and further analyses or preparation operations are prepared, e.g. for visual presentation on a monitor or the like with the option of further visual inspection.

Devices of this type, which are to be assumed to be known, have the advantage for example compared to so-called tactile measuring methods (in which a workpiece can typically be scanned using its outer contour by means of three-dimensionally movable scanners) of also being able to reliably capture and depict inner regions and cavities or undercuts of a workpiece, which are not mechanically accessible, so that, beyond the application spectrum of known scanner coordinate measuring devices, computer-tomographic non-medical workpiece measurement is in particular also beneficially suitable for purposes of assembly and defect checking, porosity analysis, for wall thickness measurement or for other complex measurement analyses, through to reverse engineering tasks in the case of which, starting from a measurement object which is physically present, the outer and inner contour data obtained can then be transformed to suitable CAD data.

Generic computer-tomographic workpiece measuring devices conventionally use hardware, x-ray sources, which have a punctiform beam outlet and linear or (approximately) square detector arrays (particularly in the present field of so-called cone-beam tomography with detectors arranged in two dimensions) assigned to this x-ray source. Due not least to the geometric conditions of the detectors which originate from medical technology, these typically have pixel sizes in the ranges between approximately 200 and 400 μm, whereby, to achieve a satisfactory precision, a workpiece support unit, arranged between the x-ray source and the detector, is placed approximately centrally or towards the x-ray source, in order to achieve the desired enlargement of the radiographed x-ray image in accordance with the detector geometry and its resolution.

A conventional process of this type has the disadvantage however, that in the case of these geometric conditions and a constant instability of the x-ray tubes, undesired movements in the beam emitted by the x-ray source are present, which then show themselves on the detector side in blurring of the image. This means that image quality and resolution are limited. The conventional geometry of the partners involved, x-ray source, detector and support unit, also leads to devices known from the prior art typically being mechanically large, with the disadvantage associated therewith of high housing, shielding and support outlay: As a matter of principle, x-ray tomography requires (lead) shielding of the relevant passages, so that large mechanical dimensions (particularly in relation to the dimensions of a workpiece to be tested) disadvantageously affect production costs, weight and preconditions for installation (such as the requirement for additional mechanical reinforcement on a substrate).

### SUMMARY OF THE INVENTION

It is therefore the object of the present invention to improve a generic computer-tomographic workpiece measuring device with regards to its measuring and imaging properties, at the same time to create the possibility of structuring such a device more compactly and with a smaller mechanical outlay in a reliable manner.

The object is achieved by means of the device with the features of the main claim, as well as the use according to Claim 16; advantageous developments of the invention are described in the subclaims. In addition, in the context of the present invention, protection is claimed for an operating method for measuring the workpiece supported on the workpiece support unit, particularly for automatically measuring a plurality of individual workpieces which can be arranged one above the other along the direction of the central or rotational axis (if appropriate, a plurality of workpieces per level) and brought one after the other into the beam path or out of the same by means of the movement according to the invention.

This object is achieved in a manner which is advantageous according to the invention by means of three mutually complementing or synergistically supporting measures: on the one hand, provision is made according to the invention, to provide the support unit (with the workpiece to be measured and to be placed thereupon) relatively closer to the detector means, in particular to provide it such that, with respect to a centre of the path between x-ray source and detector, the support unit is closer to the detector means. This measure is connected to the measure according to the invention of using small detector pixels, namely those, the maximum pixel size of which is smaller than 100 μm. As a result, the image quality can be increased significantly, as—with resolution which is the same or improved compared to the prior art—undesired movements or instabilities of the x-ray source have less of an effect.

In addition, this geometry enables the realisation of a substantially compacter arrangement, as, due to the measures described, the spacing between x-ray source and detector means can actually be reduced.

According to the invention, these features are associated with the movability of the workpiece support unit, particularly in a vertical direction (“vertical” being understood as meaning along the central or rotational axis of the workpiece support unit and thus parallel to the flat or narrow side of the detector means). Advantageously, according to the invention, this movability namely creates the possibility of providing a workpiece as measurement object on the workpiece support unit, which workpiece extends along the vertical direction beyond the detector unit, so that by means of (continuous or sectional) movement along the vertical direction successively, the various sections of this workpiece can be captured, in other words, the device is already suitable for workpieces, the dimensions of which (clearly) exceed the geometric conditions of beam path and effective detector surface. A second advantage is connected with this: if (typically elongate) objects of this type are orientated vertically on the workpiece support unit by means of their longitudinal axis (in contrast for example with typically known processes, in which an object of this type lies transversely and flat and therefore completely in the beam path), the volume of the workpiece radiographed or to be radiographed by the x-ray beam is reduced. This then in turn enables a higher image quality of the signal captured by the detector means, due to the smaller path lengths radiographed in the object. Furthermore, flat (narrow) detectors, which in the manner according to the invention at least have a rectangle ratio of the narrow to the long side of 1.5:1, cause reduced reconstruction errors due to this flat structure. In turn, a preferred development of the invention is connected with this inventive aspect, for which protection is claimed independently as use, but also in the context of a method: if, namely in the manner claimed according to the invention, a vertical movement is realised, not only one (single) object can be placed vertically, this process also offers the possibility of configuring the workpiece support unit (or providing it with suitable support means) in such a manner that the same can support a plurality of individual workpieces one above the other (also a plurality next to one another per height level) in an arranged manner. This then also enables a preferably automated successive processing of individual workpieces, in the manner of a vertical magazine, which workpieces are moved by the vertical movement of the workpiece carrier one after the other into the beam path (or out of the same again). Particularly from the standpoint of 24 hour operation with minimal manual control of a device according to the invention, this leads to greater flexibilisation of the use possibilities of a non-medical computer-tomographic workpiece measuring device according to the present invention.

As a further inventive measure, provision is made to realise the detector means as a rectangular flat array. As a result, the compactness of the device can be increased, e.g. when constructing the flat side of this rectangular contour in the horizontal direction, in that in addition to a rotary table functionality, in accordance with a development the support unit additionally executes a longitudinal or axial movement along the rotational axis. Correspondingly arising (individual) x-ray images can then in turn suitably be combined to form complete surface and then volume models corresponding to a workpiece to be tested. The rectangular shape according to the invention, i.e. not a square shape, is additionally advantageous in that errors, which arise in the reconstruction of generic, virtually square detector images, can be reduced.

In the sense of the invention, “surface” or “flat” is not necessarily to be understood as a planar (rectangular) surface; rather this also comprises a curved surface or else a lined-up (e.g. planar) arrangement made up of individual detectors along a curved line in a facet-like manner. The side or edge length ratio according to the invention would then correspondingly be to be dimensioned by an associated curved line.

In order to ensure both the flexibility and adaptability to various possible enlargement scales, provision is made in accordance with a development to displace the detector means and in addition or alternatively the x-ray source in the direction of the beam path. It is however useful and important in the context of the present invention and in accordance with a development, in order to avoid accumulating (or multiplying) positioning and tolerance errors, to construct the pair of x-ray source and detector means in a fixed and stationary manner in the vertical direction (i.e. parallel to the central or rotational axis of the workpiece support unit), further preferred to construct the detector and source in a generally stationary manner, as the movement axis/axes is/are therefore limited to the movement of the workpiece support unit or the housing assigned to the same. Alternatively, detector and/or source can be moved horizontally, i.e. perpendicularly to the central or rotational axis, in accordance with a development, with in turn advantageously decoupled movement axes.

According to preferred embodiments of the invention, provision is namely made to design the support unit, preferably integrated into a housing, in such a manner that both the rotary table functionality, including the adjustable rotation about a rotational axis, and a linear displacement of the rotary table (bearing surface) are carried out in the axial direction simultaneously or sequentially; advantageously in this respect, the support unit constitutes a modular unit which has the respective drive means integrated into the housing and a suitable control interface for executing the movements. Actually, the housing of the support unit on the one hand would for example therefore offer the rotary drive (first drive means) for the workpiece bearing surface (which could e.g. be an upper end face of the housing), a motor would then be arranged in the housing, for example in the manner of a spindle drive, which drives a spindle out of the housing towards the ground, which effects supporting and thus the linear drive.

Further, advantageously and in accordance with a development, this support unit (or the associated housing) is additionally designed in such a manner that it can additionally effect a bearing (preferably air bearing) of the bearing surface and/or rotary table.

Further, advantageously and according to the invention in the context of preferred exemplary embodiments, provision is made for at least the components x-ray source, detector means and support unit (in the housing including drive assemblies) to be fixed together on a holding bed or suchlike continuous underlying support device. Thus, these units are further preferably not cushioned with respect to each other by elastic or other means and mounted together in a shock and/or vibration absorbing manner with respect to an underlying ground, a surrounded housing or the like, whereby this process reduces mechanical outlay in a simple and elegant manner, promotes compactness and at the same time effects optimal decoupling of disruptive environmental influences, such as vibrations or the like.

Further, advantageously the configuration offers the possibility of placing a thermally insulating disc or suchlike thermal insulation unit into the beam path between x-ray source and support unit, whereby the spacing configuration according to the invention allows sufficient space for this and nonetheless allows a compact overall arrangement. According to a development, this thermally insulating disc then allows the provision of climatising in the region of the detector unit or the workpiece support, i.e. to separate heat development in the region of the x-ray source, which is damaging for both the detector accuracy and also an undesired thermal expansion of a workpiece to be measured, in a thermally effective manner from this region which is to be understood as the measuring or environmental chamber. The measurement accuracy can therefore be increased further by means of this development according to the invention, not least as certain measurement procedures in any case require that workpieces be measured at certain reference temperatures and, for example in the case of long scanning or measuring cycles, heating up of the entire interior by the x-ray source cannot otherwise be ruled out.

According to further preferred developments of the invention, for which protection is also claimed independently together with the preamble, provision is made for analysis means assigned to or connected downstream of the detector unit to carry out the electronic preparation (in principle known from the prior art) of the pixel data into two- or three-dimensional datasets (groups) of the workpiece in such a manner that in an advantageous manner according to the invention, data preparation and/or image generation systems known from the prior art, as are used in particular in connection with mechanical scanner coordinate measuring devices, can be supplied with data directly and in this respect reused directly, without further data preparation outlay being necessary: so, namely in particular in the context of developments of the invention, provision is made and it is preferred to generate and to provide a plurality of three-dimensional point and/or surface data in accordance with the (typically standardised) measurement data formats of known mechanical scanner coordinate measuring devices, in order in this manner to then enable image generation, generation of raster or grid patterns or else of CAD data, downstream.

As a result, the present invention allows the production, in a surprisingly simple and elegant manner, of compact, high-performance and operationally reliable computer-tomographic workpiece measuring devices which promise potentially considerable reductions in dimensions and cost savings connected therewith, and, in the case of additionally potentially increased imaging and measurement quality, can also make the advantages of non-medical computer-tomographic workpiece measurement available to new fields of application.

### BRIEF DESCRIPTION OF THE DRAWINGS

Further advantages, features and details of the invention result from the following description of preferred exemplary embodiments, as well as on the basis of the drawings. In the figures:

FIG. 1: shows a schematic view of the computer-tomographic workpiece measuring device according to a first preferred embodiment of the invention (best mode);

FIG. 2: shows a schematic view for clarifying the geometric conditions between x-ray source, support unit and detector means including relative movability between the same, and

FIG. 3: shows a block diagram for clarifying essential functional components and their interaction in the realisation of a system for computer-tomographic workpiece measurement including interface technology for known display and analysis peripheral equipment of scanner coordinate measuring devices.

### DETAILED DESCIPTION OF THE PREFERRED EMBODIMENT(S)

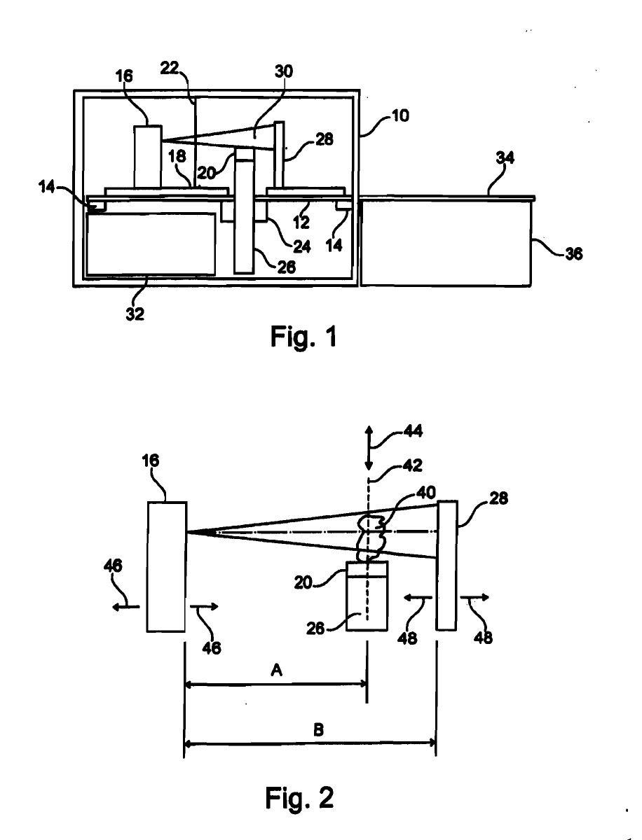

FIG. 1 clarifies in schematic side view, how, within a frame 10 offering radiation protection (e.g. by means of lead lining) on a base plate 12 (holding bed), which is supported via damper units 14 in a damping (shock and/or vibration inhibiting) manner with respect to the frame 10, an x-ray source 16 (e.g. closed microfocus or macrofocus x-ray source) is provided. The x-ray source 16 can be moved and adjusted linearly along a path, illustrated schematically by an adjustment unit 18 and also arrows 46 in FIG. 2, in order in this respect to be able to carry out an adaptation to a measurement object (workpiece) which can be provided on a rotary table 20.

Separated from the x-ray source 16 with a disc-like thermal insulation protective shield 22 which is permeable for x-ray radiation, the rotary table 20 sits on a housing unit 26 which can be moved vertically linearly by means of a bearing unit 24 and inside carries a rotary assembly (e.g. stepper motor) for driving the rotary table 20 and also has the necessary apparatuses for (preferably air-bearing) vertical movement within the plate 12 in the otherwise known manner. In the region to the right of this disc, a climatisable chamber is created by means of the thermal insulation protective screen 22, which chamber can according to a development (in a manner not shown) be provided with otherwise known climatising means in such a manner that the heat sensitive region of the detector unit or the workpiece support unit can thus be kept at a predeterminable temperature and in particular remains unaffected by disadvantageous heat generation of the x-ray source 16.

Furthermore, a detector unit 28 is mounted on the base plate 12, which is positioned at the end of a schematically shown beam path 30 in such a manner relatively to the x-ray source and to the rotary table 20, that an x-ray beam radiographing a workpiece 30 hits the detector unit 28 and there is absorbed pixel by pixel by a plurality of angularly/flat arranged x-ray sensitive semiconductor photoelements and passed to further processing. To be more precise, in the present exemplary embodiment, an x-ray detector is provided, which has an effective sensor area of 7.5 cm (horizontally)×5 cm (vertically) at a resolution of 200 pixels per cm (therefore corresponding to a total number of pixels of approx. 1500000 pixels).

The output signal of the same is fed to a control unit 32 and is then available for computational further processing, image preparation or other interface functions; in a beneficial configuration in terms of apparatus design, as shown schematically in FIG. 1, a desk surface 34 is directly assigned to the frame-like housing 10, so that the compactness of the arrangement is further increased. The desk surface 34 additionally offers the possibility in the substructure 36 to provide further processing apparatuses, e.g. a computer array. The integration of the desk surface is also claimed independently and in connection with the preamble as an invention.

As a result, an extremely compact system is created by the configuration shown, brought about not least by the geometric conditions between the assemblies involved, which are clarified in detail in FIG. 2: thus, in the exemplary embodiment shown, in a typical measuring position (for example for a measurement object 40 with a horizontal extent of 6.5 mm), the x-ray source 16 is at a distance B=40 cm from the detector unit 28. At the same time, in this configuration, the x-ray source A is at a distance A of 36.5 cm from the rotary table unit 20 or the housing unit 26 (more precisely: from a central axis 42 which extends centrally through these units). Accordingly, a ratio A/B of 0.915 results for this configuration.

As FIG. 2 additionally clarifies, the workpiece 40 can be displaced by a vertical displacement, indicated by the double arrow 44; a typical example for a maximum displacement is approx. 20 cm. Provision is also made in the context of the invention, to construct the x-ray source 16 such that it can be displaced by a horizontal linear displacement of 20 cm (arrow 46) just as (or alternatively) the detector unit 28 is constructed such that it can be displaced by a horizontal linear displacement 48 of 10 cm.

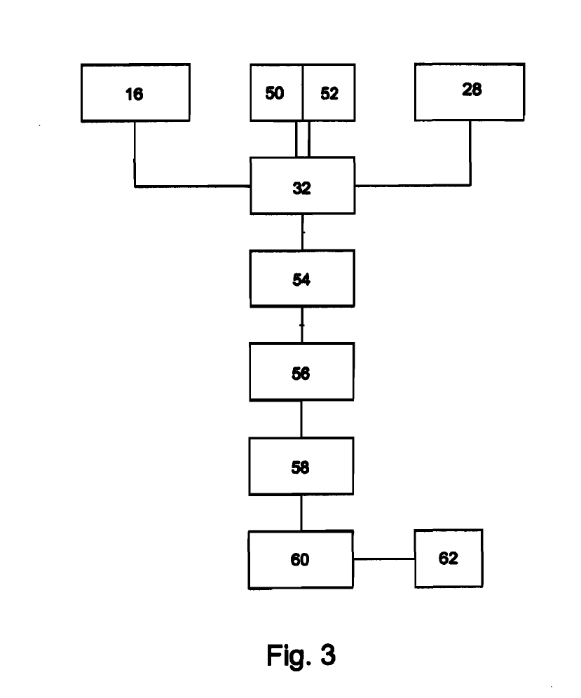

FIG. 3 clarifies the schematic interaction of the functional units with an assigned preparation and analysis unit: to be more precise, the x-ray source 16, the detector unit 28 and also a rotary control 50 or a vertical movement control 52 (for the rotary table 20 or the vertical lifting drive 26) together with the control unit 32 shown schematically in FIG. 1, which on the one hand controls the required movements of the units and on the other hand controls the emissions of the x-ray source and also effects the radiation detection by the detector unit 28 and the capturing of the incoming pixel signals. These signals are initially stored in a downstream two-dimensional image storage 54 as a plurality of (two-dimensional) individual images, in order then to be combined or allocated in a further downstream three-dimensional processing unit 56 to form a three-dimensional (volume) image.

In an advantageous manner according to the invention, in this exemplary embodiment shown, these three-dimensional data of the unit 56 are additionally available in the manner of 3D datasets, points and/or vectors and in accordance with typical interface or data formats of scanner coordinate measuring devices at an interface unit 58, in order, as shown in FIG. 3, to be connected to a downstream standardised analysis unit 60 (as can typically also interact with the very same known scanner coordinate measuring devices) and to output an analysis result for a display unit 62, e.g. a screen, a printer or the like.

The units shown in FIG. 3 as functional components can exist as discretely realised hardware modules and in addition or alternatively in the form of suitably programmed computer or controller units, if appropriate as clusters of parallel computers.

1-16. (canceled)

17. A computer-tomographic workpiece measuring device comprising:
an x-ray source constructed for generating invasive radiation,
detector means for capturing the invasive radiation and a workpiece support unit having one of a central and a rotational axis, which is constructed in such a manner that a workpiece supported by the workpiece support unit and to be measured can be placed in a beam path of the invasive radiation between the x-ray source and the detector means and can be moved along one of the central and rotational axis, in the beam path;
a ratio of a first smallest distance A between a beam outlet of the x-ray source and the central or rotational axis of the support unit extending in the beam path in relation to a second smallest distance B between the beam outlet and the detector means having a plurality of detector pixels arranged two-dimensionally in an area A/B is >0.5;
a side and/or edge length ratio of the area of the detector means lies in the range between 1.5:1 to 500:1;
the detector pixels have a maximum pixel size smaller than 100 μm.

18. The computer-tomographic workpiece measuring device of claim 17, wherein A/B is >0.7, the side length ratio lies in the range between 2:1 and 100:1 and the maximum pixel size is smaller than 80 μm.

19. The computer-tomographic workpiece measuring device of claim 17, wherein A/B is >0.8 and the maximum pixel size is smaller than 50 μm.

20. The device according to claim 17, wherein the detector means and/or the x-ray source are constructed in such a manner that the same can be adjusted and/or displaced in one direction of the beam path.

21. The device according to claim 17, wherein the support unit has a rotary table functionality with a workpiece bearing surface which can be driven rotationally about a rotational axis.

22. The device according to claim 21, wherein the support unit is constructed in such a manner that the workpiece bearing surface can be moved along the rotational axis by a predetermined longitudinal displacement.

23. The device according to claim 22, wherein the support unit has a housing which has first driving means for rotating the workpiece bearing surface about the rotational axis and second driving means for linearly moving the workpiece bearing surface along the rotational axis, and wherein at least one of the first and second driving means is integrated into the housing.

24. The device according to claim 23, wherein the first and the second driving means are constructed and can be controlled in such a manner that rotation and linear movement can take place simultaneously.

25. The device according to claim 21, wherein the support unit has a bearing with a workpiece bearing surface on or in a movable housing or carriage of the support unit.

26. The device according to claim 25, wherein said bearing is an air bearing.

27. The device according to claim 17, wherein the x-ray source, the detector means and the support unit having drive means are fixed on a common holding bed, which holding bed is preferably supported with respect to a substrate and/or a surrounded housing in a shock and/or vibration absorbing manner by means of mechanical cushioning means.

28. Device according to one of claims 1 to 8, characterised by a disc-like thermal insulation unit (22), which is permeable for x-ray radiation, in the beam path between the x-ray source (16) and the support unit (20, 24, 26).

10. Device according to claim 9, characterised in that the thermal insulation unit closes a temperature controlled chamber, having a climatising means, for the workpiece support unit, in which the workpiece support unit and also the detector means are provided.

11. Device according to one of claims 1 to 10 characterised in that electronic analysis means (58, 60) are connected downstream of the detector unit, which are constructed in such a manner that they generate and electronically output three-dimensional contour data of a measured workpiece from a plurality of x-ray detector images of the detector unit in accordance with a measurement data format of a mechanical scanner coordinate measuring device.

12. Device according to claim 11, characterised in that the three-dimensional contour data have three-dimensional point and/or surface data and/or object dimension data and are electronically structured and/or prepared in such a manner that they can be converted into visual representations by image generation systems (62) of a scanner coordinate measuring device.

13. Device according to one of claims 1 to 12, characterised in that the workpiece measuring device is provided in a housing and/or a surrounding frame structure and a desk section or desk attachment (34) is constructed on the housing or the frame structure (10).

14. Device according to one of claims 1 to 13, characterised in that means for accommodating and/or holding a plurality of workpieces to be measured in the direction of the central or rotational axis one above the other are assigned to the workpiece support unit in such a manner that the plurality of workpieces can successively be measured, preferably in an automated manner, by means of the controlled movement of the workpiece support unit along the central or rotational axis.

15. Device according to claim 14, characterised in that the means for accommodating or holding form a plurality of levels along the central or rotational axis, of which at least one level is configured for accommodating a plurality of workpieces in this level.

16. Use of the device according to one of claims 1 to 15 for the automated measurement of a plurality of workpieces provided above one another on the workpiece support unit along the direction of the central or rotational axis by means of successive movement of the workpieces into the beam path.
